(19) United States
(12) Patent Application Publication
(10) Pub. No.: US 2006/0056659 A1
(43) Pub. Date: Mar. 16, 2006

(54) System and method for the detection of bluestain and rot on wood

(76) Inventors: John Laurent, Saint-Augustin-de-Desmaures (CA); Mario Talbot, Beauport (CA); Daniel Ethier, Blainville (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/198,395

(22) Filed: Aug. 8, 2005

(30) Foreign Application Priority Data
Aug. 6, 2004 (CA) 2,478,757

(51) Int. Cl. G06K 9/00

(52) U.S. Cl. 382/110

(57) ABSTRACT

A system for detecting bluestain and rot in wood in a wood processing plant including a conveyor for conveying a piece of wood through a scanning area includes a scanning unit comprising a plurality of scanners arranged to scan a face of the piece of wood in a direction perpendicular to a conveying direction. Each of the scanners include a light for illuminating a point on the piece of wood; a collector for collecting light reflected from the piece of wood; a splitter for splitting the collected light into at least two beams; a filter for filtering out of each of the beams a wavelength associated with each of the beams, each of the wavelengths being different; a collector for collecting the filtered light, the collector being adapted to output a signal related to an intensity of the filtered light; and a comparator for comparing the output of each of the collector, the comparator being adapted to output a signal when a ratio between the signal between each of the collector exceeds a predetermined threshold.

### FIELD OF THE INVENTION

The present invention relates to a system and method for the detection of bluestain and rot on wood. More specifically, the present invention concerns such a system and method where the detection is made by spectrally analysing light reflected off the wood.

### DESCRIPTION OF THE PRIOR ART

The quantity of wood that is stained with bluestain is constantly increasing, particularly since the forests of British Columbia have been infested with an insect known as mountain pine beetle. This type of wood is easily distinguished from other woods by its blue colour, due to the fungi carried by the insect. The volume of bluestain wood treated by mills increases, but consumers are reluctant to use this wood, even though studies have demonstrated that the physical properties of the wood are unaffected. Mill operators would like to the able to grade bluestain wood during the early stages of classification, either at the planing step or at the cutting step. The colour of bluestain wood, varying from grey to black, is also akin to that of rot. Hence, a sensor for detecting bluestain must detect not only bluestain but also rot, without being affected by the other natural defects of the wood.

There is not presently technology available in sawmills (and particularly those of first transformation) which permits the detection of bluestain. There are scanners that exist, but they are used in mills of secondary transformation. Most of the scanners are based on 2D colour cameras, the image of which is then analysed by a computer program. The problem is that the colour of the bluestain is difficult to determine with any certainty from a colour image, and is easily mistaken for other defects. Furthermore, the computer programs are based on complicated algorithms which compare regions of the image in order to make a determination, which makes the processing of the image heavy and difficult to implement in real time. The detection level being low, human intervention is generally required to make a final classification of the wood.

### SUMMARY OF THE INVENTION

It is an object of the present invention to provide a system and method for detecting bluestain and rot on a piece of wood which is based on a spectral analysis of the piece of wood.

In accordance with one aspect of the invention, there is provided a system for detecting bluestain and rot in wood in a wood processing plant, said wood processing plant including a conveyor for conveying a piece of wood through a scanning area, said system comprising:
a scanning unit comprising a plurality of scanners arranged to scan a face of said piece of wood in a direction perpendicular to a conveying direction of said piece of wood, each of said scanners comprising:
a light for illuminating a point on said piece of wood;
a collector for collecting light reflected from said piece of wood;
a splitter for splitting said collected light into at least two beams;
a filter for filtering out of each of said beams a wavelength associated with each of said beams, each of the wavelengths being different;
a collector for collecting the filtered light, said collector being adapted to output a signal related to an intensity of said filtered light; and
a comparator for comparing the output of each of the collector, said comparator being adapted to output a signal when a ratio between said signal between each of said collector exceeds a predetermined threshold.

In accordance with another aspect of the invention, there is provided a system for grading a piece of wood based on the detection of bluestain and rot, said system comprising:
a first scanning unit according to claim 1 for scanning a top of said piece of wood;
a second scanning unit according to claim 1 for scanning a bottom of said piece of wood;
a data collector which synchronizes said output of said comparator with the passage of said wood piece through said scanning area in order to scan said wood piece at a predetermined interval, for collecting said output of each of said comparator; and
a grading computer for grading said piece of wood according to data collected by said data collector.

In accordance with yet another aspect of the invention, there is provided a method for detecting bluestain and rot in wood comprising the steps of:
(a) providing a scanning unit comprising a plurality of scanners arranged to scan a face of said piece of wood in a direction perpendicular to a conveying direction of said piece of wood;
(b) with said scanning unit:
   (i) illuminating a point on said piece of wood;
   (ii) collecting light reflected from said piece of wood;
   (iii) splitting said collected light into at least two beams;
   (iv) filtering out of each of said beams a wavelength associated with each of said beams, each of the wavelengths being different;
   (v) collecting the filtered light with a collector adapted to output a signal related to an intensity of said filtered light;
   (vi) comparing the output of each of the collector; and
   (vii) outputting a signal when a ratio between said signal between each of said collector exceeds a predetermined threshold.

### BRIEF DESCRIPTION OF THE DRAWINGS

The invention will be described in more detailed in the following description of a preferred embodiment of the invention, made with reference to the following drawings in which:

FIG. 1 is schematic representation of a system for grading a piece of wood conveyed in a longitudinal direction, consisting of two scanning units, a data collector and a grading computer;

FIG. 2 is cross-sectional view of FIG. 1 showing only the top scanning unit;

FIG. 3 is a schematic representation of the arrangement of the light, the lens and the filters and detectors;

FIG. 4 is a bottom view of a scanning unit;

FIG. 5 is a detailed view of the scanner, showing details different from those of FIG. 3; and

FIG. 6 is a schematic view of two scanning units for each surface of the piece of wood, offset from each other.

### DESCRIPTION OF A PREFERRED EMBODIMENT OF THE INVENTION

As mentioned previously, the present invention is based on a spectral analysis of the piece of wood. This provides the advantage that the detection does not depend on the interpretation of an image, as in the scanners of the prior art, but rather depends on the reaction of the wood to certain specific wavelengths of light reflected off the piece of wood.

More specifically, the present invention concerns a system for detecting bluestain and rot in wood in a wood processing plant, the wood processing plant including a conveyor 10 for conveying a piece of wood through a scanning area 12.

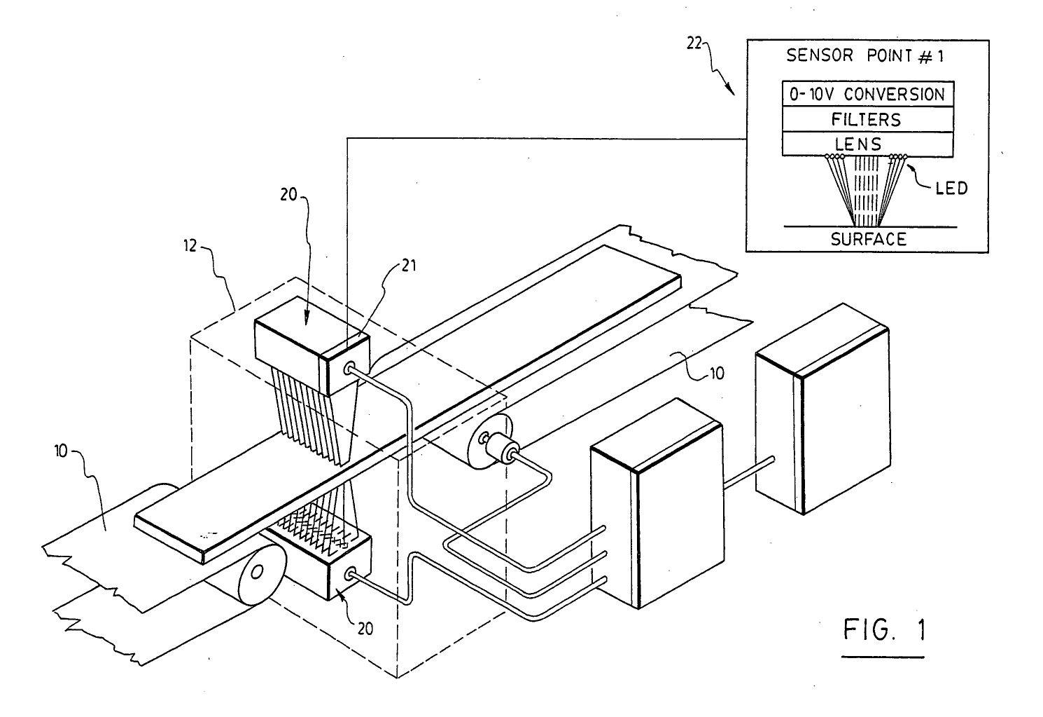

The system includes a scanning unit 20 comprising a plurality of scanners 22 arranged to scan a face of the piece of wood in a direction perpendicular to a conveying direction of said piece of wood. The scanning unit can be monolithical, in that it is made of a single piece, or could be made of a plurality of individual scanners mounted together. In FIG. 1, the scanners are individual.

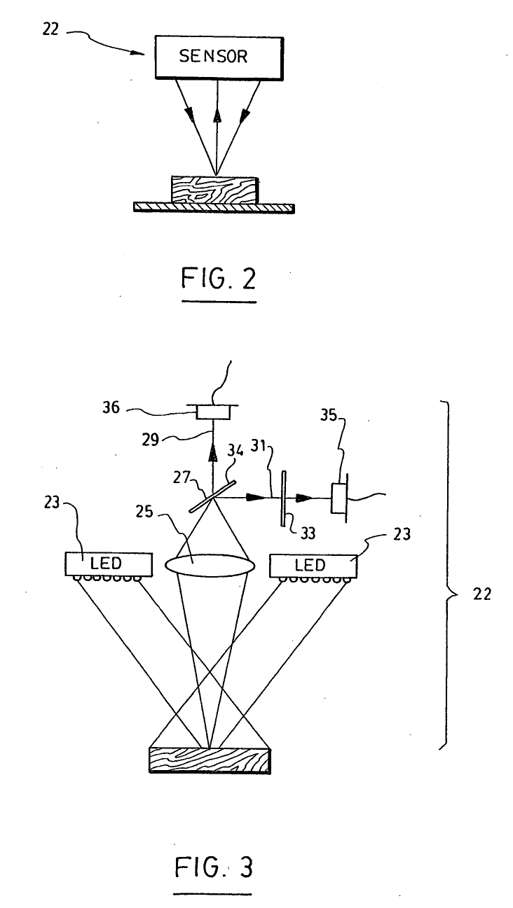

Referring now to FIGS. 2, 3 and 5, each of the scanners includes a light 23 for illuminating a point on said piece of wood. There is also provided a collector 25 for collecting light reflected from the piece of wood; a splitter 27 for splitting the collected light into at least two beams 29, 31; and a filter 33, 34 for filtering out of each of the beams 29, 31 a wavelength associated with each of the beams, each of the wavelengths being different. The scanners further include a collector 35, 36 for collecting the filtered light, the collector being adapted to output a signal related to an intensity of said filtered light; and a comparator 37 for comparing the output of each of the collector, the comparator being adapted to output a signal when a ratio between the signal between each of said collector exceeds a predetermined threshold.

As better shown in FIGS. 3 and 5, the light 23 is preferably LEDs. More preferably, the LEDs are arranged in a line (which is parallel to the conveying direction of the piece of wood). In order to provide better results, the LEDs are further disposed on either side of the collector 25, which is in a preferred embodiment a lens. Further preferably, the LEDs are selected to emit light in the spectrum of 900 to 1200 nm. Given the fact that pieces of wood have varying thicknesses, the LEDs are adapted to illuminate the piece of wood with a stable intensity for a depth of 3 inches (see FIG. 2). Thus, the scanning unit 22 is preferably placing 6 inches away from the conveyor 10.

As shown in FIG. 3, the splitter 27 and filter 34 are a single component, as a person skilled in the art of optics would readily understand. The detectors 35, 36, as shown in FIG. 5, are preferably mounted on PCBs, which further include the electronic components required to output the signal related to the intensity of light. Such detectors are well known, and are readily available.

The comparator 27 is also a well known component, and details of its construction are not included herein. However, the output of the comparator is preferably an analog signal, varying for example between 0-10 V, indicative of the strength of the signals received by the collectors.

As mentioned previously, the present invention is based on a spectral analysis of the light reflected from the piece of wood. It has been found that although a single wavelength may be used for the purpose of detecting bluestain and rot, the efficiency and accuracy of the system is further increased by comparing a ratio between the intensity of at least two wavelengths. It should be noted that the ration can compare three or more wavelengths, but accuracy does not necessarily increase.

The inventors have found that the best results occur in the range of 900-1200 nm. Two combinations of wavelengths have been found to be the best: the ratio of 985 nm over 965 nm (or 980 nm over 960 nm) and 1140 nm over 955 nm. The choice will most likely depend on the impact of false detections caused by knots. If a false detection would have no impact, then the first pair of wavelengths should be selected; otherwise the second should be considered.

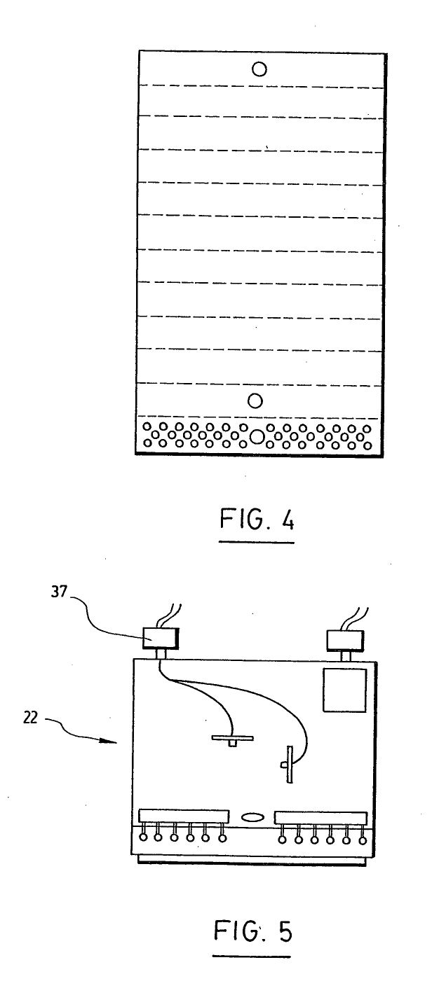

In order to provide optimal scanning, the wood is conveyed longitudinally, and the scanning unit is provided with twelve scanners, separated from each other by a distance of one inch (see FIG. 4). Of course, if the piece of wood is scanned transversely, then the scanning unit should have enough scanners to scan the whole length of the piece of wood.

The system of the present invention is further preferably connected to a data collector which is operatively associated with the conveyor. This enables the data collector to synchronize the collection of data as the piece of wood passes through the scanning area 12. Preferably, the piece of wood is scanned at every 0.125 to every 0.500 inch, depending on the accuracy required.

As is typical in sawmills, there are also grading computers, which permit the grading of a piece of wood according to a variety of surface defects, etc. The data collector can then be integrated into a grading system.

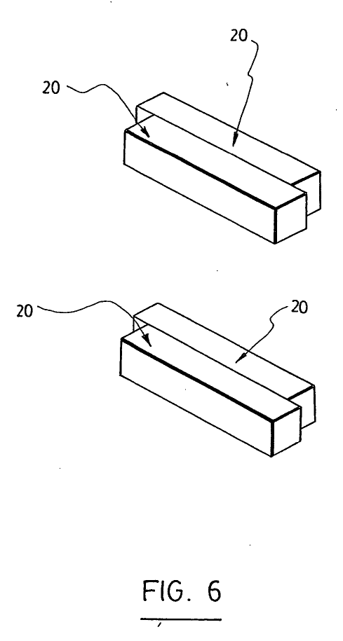

In order to provide even greater accuracy, as shown in FIG. 6, two scanning units can be placed over each surface of the piece of wood. In such a case, the scanning units on one side a offset by approximately ½ inch.

Although the present invention has been explained hereinabove by way of a preferred embodiment thereof, it should be pointed out that any modifications to this preferred embodiment within the scope of the appended claims is not deemed to alter or change the nature and scope of the present invention.

1. A system for detecting bluestain and rot in wood in a wood processing plant, said wood processing plant including a conveyor for conveying a piece of wood through a scanning area, said system comprising:
a scanning unit comprising a plurality of scanners arranged to scan a face of said piece of wood in a direction perpendicular to a conveying direction of said piece of wood, each of said scanners comprising:
a light for illuminating a point on said piece of wood;
a collector for collecting light reflected from said piece of wood;
a splitter for splitting said collected light into at least two beams;
a filter for filtering out of each of said beams a wavelength associated with each of said beams, each of the wavelengths being different;
a collector for collecting the filtered light, said collector being adapted to output a signal related to an intensity of said filtered light; and
a comparator for comparing the output of each of the collector, said comparator being adapted to output a signal when a ratio between said signal between each of said collector exceeds a predetermined threshold.

2. A system according to claim 1, wherein said light is adapted to shine a point on said piece of wood that is stable in intensity over a depth of 3 inches.

3. A system according to claim 1, wherein said light is in the range of 900-1200 nm.

4. A system according to claim 1, wherein said system includes 12 scanners, aligned with each other in a direction perpendicular to said conveying direction of said piece of wood, each of the scanners being separated by an inch.

5. A system according to claim 4, wherein said system is comprised of 12 individual scanners.

6. A system according to claim 4, wherein said system is comprised of 12 scanners monolithically assembled in one piece.

7. A system according to claim 1, wherein said system is further operatively connected to a data collector which synchronizes said output of said comparator with the passage of said wood piece through said scanning area in order to scan said wood piece at a predetermined interval.

8. A system according to claim 7, wherein said interval is between 0.125 and 0.500 inches.

9. A system for grading a piece of wood based on the detection of bluestain and rot, said system comprising:
a first scanning unit according to claim 1 for scanning a top of said piece of wood;
a second scanning unit according to claim 1 for scanning a bottom of said piece of wood;
a data collector which synchronizes said output of said comparator with the passage of said wood piece through said scanning area in order to scan said wood piece at a predetermined interval, for collecting said output of each of said comparator; and
a grading computer for grading said piece of wood according to data collected by said data collector.

10. A system according to claim 9, wherein said system further includes:
a third scanning unit according to claim 1, said third scanning unit being located adjacent said first scanning unit, and offset from said first scanning unit; and
a fourth scanning unit according to claim 1, said fourth scanning unit being located adjacent said second scanning unit, and offset from said second scanning unit.

11. A method for detecting bluestain and rot in wood comprising the steps of:
(a) providing a scanning unit comprising a plurality of scanners arranged to scan a face of said piece of wood in a direction perpendicular to a conveying direction of said piece of wood;
(b) with said scanning unit:
(i) illuminating a point on said piece of wood;
(ii) collecting light reflected from said piece of wood;
(iii) splitting said collected light into at least two beams;
(iv) filtering out of each of said beams a wavelength associated with each of said beams, each of the wavelengths being different;
(v) collecting the filtered light with a collector adapted to output a signal related to an intensity of said filtered light;
(vi) comparing the output of each of the collector; and
(vii) outputting a signal when a ratio between said signal between each of said collector exceeds a predetermined threshold.
